(19) United States
(12) Patent Application Publication
(10) Pub. No.: US 2026/0163640 A1
(43) Pub. Date: Jun. 11, 2026

(54) APPARATUS FOR MEASURING HALF-WAVE VOLTAGE OF PHASE MODULATOR AND OPERATING METHOD THEREOF

(71) Applicant: ELECTRONICS AND TELECOMMUNICATIONS RESEARCH INSTITUTE, Daejeon (KR)

(72) Inventors: Junsang OH, Daejeon (KR); Chun Ju YOUN, Daejeon (KR); Kap-Joong KIM, Daejeon (KR); Dong Churl KIM, Daejeon (KR); Minchul KIM, Daejeon (KR); Ju Hee BAEK, Daejeon (KR); Kyongchun LIM, Daejeon (KR); Byung-seok CHOI, Daejeon (KR); Joong-Seon CHOE, Daejeon (KR)

(21) Appl. No.: 19/278,012

(22) Filed: Jul. 23, 2025

(30) Foreign Application Priority Data
Dec. 10, 2024 (KR) 10-2024-0182687
Apr. 10, 2025 (KR) 10-2025-0046597

(51) Int. Cl. H04B 10/079; H04B 10/548

(52) U.S. Cl. CPC H04B 10/0795; H04B 10/548

(57) ABSTRACT

A device for measuring half-wave voltage includes a light source that outputs an input optical signal, a beam splitter that separates the input optical signal into a first optical signal and a second optical signal and generates an interference signal based on the first optical signal and the second optical signal, a plurality of polarization controllers that adjust polarization states of optical signals, a phase modulator that adjusts a phase of the second optical signal based on an input voltage, a polarization beam splitter that determines propagation directions of the first optical signal and the second optical signal, a Faraday mirror that reflects by converting the polarization states of the optical signals output from the polarization beam splitter, and an optical detector that detects the interference signal and measures the half-wave voltage of the phase modulator based on the detected interference signal.

### CROSS-REFERENCE TO RELATED APPLICATIONS

This application claims priority under 35 U.S.C. § 119 to Korean Patent Applications No. 10-2024-0182687 filed on Dec. 10, 2024, and No. 10-2025-0046597 filed on Apr. 10, 2025, in the Korean Intellectual Property Office, the disclosures of which are incorporated by reference herein in their entireties.

### BACKGROUND

### 1. Field of the Invention

Embodiments of the present disclosure herein relate to a device for measuring a half-wave voltage of a phase modulator, and more particularly, relate to a device for determining the half-wave voltage of the phase-modulator in a pulsed optical signal environment and operating method thereof.

### 2. Description of Related Art

In the field of optical communication and optical signal processing, an optical phase modulator is an element used for adjusting a phase of an optical signal. Conventionally, a measurement device using a continuous-wave (CW) optical signal has been developed to measure a half-wave voltage of the optical phase modulator. The measurement device based on the CW optical signal enables accurate measurement, as it handles a signal having a constant optical intensity and phase variation (or phase change).

Recently, systems using pulsed optical signals for high-speed communication and optical signal processing have been increasing. The pulsed optical signal has a strong optical intensity for a very short time and requires a measurement with a high temporal resolution. Conventional measurement devices based on the CW optical signal have limitations in accurately measuring the half-wave voltage, as they are unable to track the rapid temporal variations of the pulsed optical signal. This causes difficulty in achieving optimal performance of the phase modulator in systems based on a pulsed optical signal.

Accordingly, there is a need for a measurement device capable of accurately measuring the half-wave voltage in various optical signal environments including the pulsed optical signal.

### SUMMARY

Embodiments of the present disclosure provide a device for measuring a half-wave voltage of a phase modulator in a pulsed optical signal environment and an operating method thereof.

According to an embodiment of the present disclosure, a device for measuring half-wave voltage comprises a light source that outputs an input optical signal, a beam splitter that separates the input optical signal into a first optical signal and a second optical signal and generates an interference signal based on the first optical signal and the second optical signal, a plurality of polarization controllers that adjust polarization states of optical signals, a phase modulator that adjusts a phase of the second optical signal based on an input voltage, a polarization beam splitter that determines propagation directions of the first optical signal and the second optical signal, a Faraday mirror that reflects by converting polarization states of the optical signals output from the polarization beam splitter, and an optical detector that detects the interference signal and measures the half-wave voltage of the phase modulator based on the detected interference signal. The first optical signal and the second optical signal propagate along the same optical path in opposite directions.

According to an embodiment of the present disclosure, the input optical signal is a CW optical signal or a pulsed optical signal.

According to an embodiment of the present disclosure, the plurality of polarization controllers include a first polarization controller that corrects the polarization states of the optical signals, and a second polarization controller that converts the polarization states of the optical signals by 90 degrees.

According to an embodiment of the present disclosure, the optical path includes a first path that includes the first polarization controller, a second path between the polarization beam splitter and the Faraday mirror, and a third path that includes the phase modulator and the second polarization controller.

According to an embodiment of the present disclosure, the first optical signal propagates sequentially through the first path, the second path, and the third path, and the second optical signal propagates sequentially through the third path, the second path, and the first path.

According to an embodiment of the present disclosure, the beam splitter combines the first optical signal propagated through the third path and the second optical signal propagated through the first path to generate the interference signal.

According to an embodiment of the present disclosure, the separated first optical signal has horizontal first polarization state. The Faraday mirror converts the separated first optical signal to have a second polarization state. The second polarization controller converts the converted first optical signal to have the first polarization state. The first polarization state and the second polarization state are orthogonal.

According to an embodiment of the present disclosure, the separated second optical signal has the first polarization state. The second polarization controller converts the separated second optical signal to have the second polarization state. The Faraday mirror converts the converted second optical signal to have the first polarization state.

According to an embodiment of the present disclosure, the first polarization state is a polarization state in a direction aligned with a crystal axis of the phase modulator.

According to an embodiment of the present disclosure, the separated first optical signal and the separated second optical signal have the same intensity.

According to an embodiment of the present disclosure, the device is based on a Faraday-Michelson interferometer.

According to an embodiment of the present disclosure, the beam splitter includes a polarization-maintaining optical fiber to maintain the polarization states of the optical signals.

According to an embodiment of the present disclosure, the first path includes a delay-matching optical fiber to match the length with the second path.

According to an embodiment of the present disclosure, the optical detector is an oscilloscope that converts the interference signal into an electrical signal and detects the electrical signal.

According to an embodiment of the present disclosure, the device further comprises an RF signal generator that applies the input voltage to the phase modulator.

A method for operating a device for measuring half-wave voltage, comprises outputting an input optical signal, separating the input optical signal into a first optical signal and a second optical signal, wherein the first optical signal propagates in a first direction and the second optical signal propagates in a second direction, adjusting a polarization state of the first optical signal, adjusting a phase and a polarization state of the second optical signal, combining the adjusted first optical signal and the adjusted second optical signal to generate an interference signal, and measuring the half-wave voltage based on the interference signal.

According to an embodiment of the present disclosure, the input optical signal is a CW optical signal or a pulsed optical signal.

According to an embodiment of the present disclosure, the optical path includes a first path, a second path, and a third path. The first direction is in order of the first path, the second path, and the third path. The second direction is in order of the third path, the second path, and the first path.

According to an embodiment of the present disclosure, the adjusting of the phase and the polarization state of the second optical signal includes adjusting the phase of the second optical signal based on the input voltage.

According to an embodiment of the present disclosure, the measuring of the half-wave voltage based on the interference signal includes detecting the interference signal, and measuring the half-wave voltage based on detection voltage and phase variation of the detected interference signal.

### BRIEF DESCRIPTION OF THE DRAWINGS

The above and other objects and features of the present disclosure will become apparent by describing in detail embodiments thereof with reference to the accompanying drawings.

FIG. 1 illustrates a device for measuring a half-wave voltage of a phase modulator, according to an embodiment of the present disclosure.

FIG. 2 illustrates an example of a propagation of the first optical signal in the device of FIG. 1.

FIG. 3 illustrates an example of a propagation of the second optical signal in the device of FIG. 1.

FIG. 4 illustrates an example of an input voltage applied to the device of FIG. 1.

FIG. 5 illustrates an example of an interference signal detected in the device of FIG. 1.

FIG. 6 illustrates an example of operation of a device for measuring a half-wave voltage of a phase modulator, according to an embodiment of the present disclosure.

### DETAILED DESCRIPTION OF THE INVENTION

Hereinafter, embodiments of the present disclosure may be described in detail and clearly to such an extent that an ordinary one in the art easily implements the present disclosure.

Hereinafter, the preferred embodiments of the present disclosure will be described in detail with reference to the accompanying drawings. The advantages, features, and methods of achieving the present invention will become more apparent from the following detailed description taken in conjunction with the accompanying drawings. However, it should be understood that the present invention is not limited to the embodiments described herein and may be embodied in various other forms. Rather, the embodiments introduced here are provided to make the disclosed content thorough and complete, and to ensure that the concepts of the disclosure are sufficiently conveyed to those skilled in the art, and the disclosure is defined only by the scope of the claims. Throughout the specification, the same reference numerals refer to the same components.

The terms used in the specification are for the purpose of describing the embodiments and are not intended to limit the disclosure. In this specification, the singular form includes the plural form unless specifically stated otherwise in the context. The terms ‘comprise’ and/or ‘comprising’ used in the specification do not exclude the presence or addition of one or more other components, actions, and/or elements. Furthermore, since it is based on preferred embodiments, the reference numerals presented in the description are not necessarily limited by the order of presentation.

The embodiments described in this specification will be explained with reference to ideal examples such as cross-sectional and/or plan views of the disclosure. In the drawings, the thickness of the layers and regions may be exaggerated for the effective explanation of the technical content. Therefore, the shape of the example may be altered due to manufacturing techniques and/or tolerances. Thus, the embodiments of the present disclosure are not limited to the specific forms illustrated, but include changes in the shape created according to the manufacturing process.

Components that are described in the detailed description with reference to the terms “unit”, “module”, “block”, “˜er or ˜or”, etc, and function blocks illustrated in drawings will be implemented with software, hardware, or a combination thereof. For example, the software may be a machine code, firmware, an embedded code, and application software. For example, the hardware may include an electrical circuit, an electronic circuit, a processor, a computer, an integrated circuit, integrated circuit cores, a pressure sensor, an inertial sensor, a microelectromechanical system (MEMS), a passive element, or a combination thereof.

In this document, phrases such as “A or B,” “at least one of A and B,” “at least one of A or B,” “A, B, or C,” “at least one of A, B, or C,” and “at least one of A, B, or C” may include any one of the items listed in the respective phrase, or any possible combination of them.

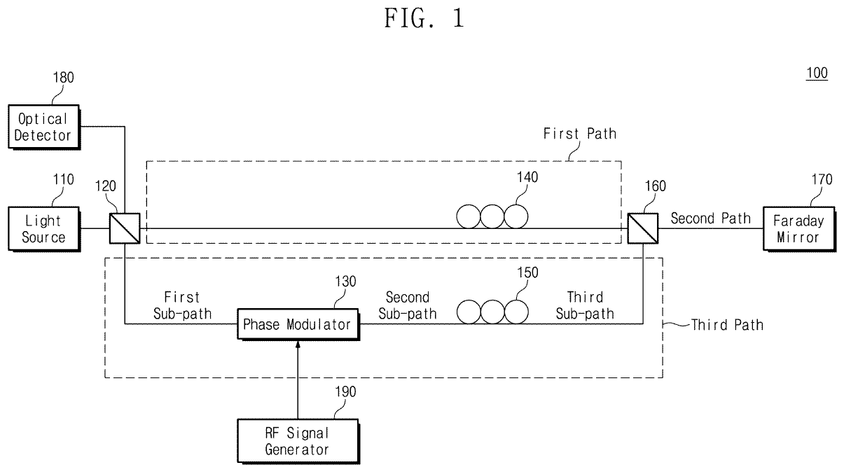

FIG. 1 illustrates a device for measuring a half-wave voltage of a phase modulator, according to an embodiment of the present disclosure.

Referring to FIG. 1, a device 100 may include a light source 110, a beam splitter 120, a phase modulator 130, a first polarization controller 140, a second polarization controller 150, a polarization beam splitter 160, a Faraday mirror 170, an optical detector 180, and an RF signal generator 190. In an embodiment, the device 100 may be configured with a Faraday-Michelson interferometer.

The light source 110 may output an input optical signal. For example, the light source 110 may output a CW optical signal or a pulsed optical signal.

The beam splitter 120 may receive an input optical signal output from the light source 110. The beam splitter 120 may separate the input optical signal into optical signals. The optical signals may include a first optical signal and a second optical signal. For example, the beam splitter 120 may separate the input optical signal into the first optical signal and the second optical signal.

In an embodiment, the beam splitter 120 may separate the input optical signal into the first optical signal and the second optical signal having the same polarization state. That is, the first optical signal and the second optical signal may have the same polarization state.

For example, polarization states of the first optical signal and the second optical signal may be horizontal polarization. Or, the polarization states of the first optical signal and the second optical signal may be vertical polarization.

In an embodiment, the beam splitter 120 may separate the input optical signal into the first optical signal and the second optical signal with an optical splitting ratio of 50:50. For example, the beam splitter 120 may separate the input optical signal into the first optical signal and the second optical signal having the same intensity.

In an embodiment, the beam splitter 120 may separate the input optical signal into the first optical signal and the second optical signal, each having a polarization state aligned with a crystal axis of the phase modulator 130. That is, the first optical signal and the second optical signal may be optical signals polarized in the same direction as the crystal axis of the phase modulator 130.

For example, when the crystal axis of the phase modulator 130 is in a horizontal direction, polarization states of the first optical signal and the second optical signal may be horizontal polarization. For example, when the crystal axis of the phase modulator 130 is in a vertical direction, the polarization states of the first optical signal and the second optical signal may be vertical polarization.

In an embodiment, the crystal axis of the phase modulator 130 may indicate a specific direction of a crystalline material included in the phase modifier 130.

The first optical signal and the second optical signal may propagate the same optical path in different directions. The optical path may include a first path, a second path, and a third path.

For example, the first optical signal may propagate in the order of the first path, the second path, and the third path. The second optical signal may propagate in the order of the third path, the second path, and the first path. In other words, the first optical signal may propagate the optical path in a first order, and the second optical signal may propagate the optical path in a second order different from the first order.

In an embodiment, the first path and the second path may be arranged in parallel or on the same line.

In an embodiment, the third path may include a first sub-path, a second sub-path, and a third sub-path. The first sub-path and the third sub-path may be perpendicular to the second sub-path. For example, the first sub-path and the third sub-path may be arranged to be parallel to each other and perpendicular to the first path (or the second path). The second sub-path may be arranged to be parallel to the first path (or the second path).

In an embodiment, the first path includes the first polarization controller 140, the second path is located between the polarization beam splitter 160 and the Faraday mirror 170, and the third path (e.g., the second sub-path) may include the phase modulator 130 and the second polarization controller 150.

In an embodiment, the first path may include a delay-matching optical fiber for matching a length with the second path.

The beam splitter 120 may generate an interference signal based on the separated first optical signal and the separated second optical signal. For example, the beam splitter 120 may combine the first optical signal after propagating through the optical path (e.g., the first optical signal after propagating through the third path) and the second optical signal after propagating through the optical path (e.g., the second optical signal after propagating through the first path). As a result of the combination, the beam splitter 120 may generate the interference signal.

In an embodiment, the beam splitter 120 may include a polarization-maintaining optical fiber. For example, the beam splitter 120 may be composed of the polarization-maintaining optical fiber.

The phase modulator 130 may be located on the third path. The phase modulator 130 may adjust a phase of the second optical signal based on the input voltage. For example, the phase modulator 130 may adjust the phase of the second optical signal output from the beam splitter 120 based on the input voltage applied from the RF signal generator 190.

The first polarization controller 140 may be located on the first path. The first polarization controller 140 may adjust polarization states of the optical signals (e.g., the first and second optical signals) propagating along the first path. For example, the first polarization controller 140 may correct the polarization states of the optical signals propagating along the first path. That is, the first polarization controller 140 may correct slight changes (e.g., errors) in the polarization state that occur as each of the optical signals propagates.

In an embodiment, the first polarization controller 140 may selectively correct the polarization states of the optical signals propagating along the first path. For example, the first polarization controller 140 may correct the polarization state of the first optical signal output from the beam splitter 120. As a result of correcting the polarization state, the first optical signal output from the beam splitter 120 may propagate to the polarization beam splitter 160 while maintaining the polarization state. For example, when the polarization state of the first optical signal output from the beam splitter 120 is horizontal polarization, the first polarization controller 140 may correct the polarization state so that the first optical signal having horizontal polarization is input to the polarization beam splitter 160.

For example, the first polarization controller 140 may correct the polarization state of the second optical signal output from the polarization beam splitter 160. As a result of correcting the polarization state, the second optical signal output from the polarization beam splitter 160 may propagate to the beam splitter 120 while maintaining the polarization state.

The second polarization controller 150 may be located on the third path. The second polarization controller 150 may adjust polarization states of the optical signals (e.g., the first and second optical signals) propagating along the third path. For example, the second polarization controller 150 may convert the polarization states of the optical signals propagating along the third path by 90 degrees.

For example, when the optical signal (e.g., the first optical signal or the second optical signal) input to the second polarization controller 150 has vertical polarization, the second polarization controller 150 may output the optical signal converted to horizontal polarization. For example, when the optical signal input to the second polarization controller 150 has horizontal polarization, the second polarization controller 150 may output the optical signal converted to vertical polarization.

The polarization beam splitter 160 may determine propagation directions of the optical signals (e.g., the first and second optical signals) based on the polarization states of the optical signals. For example, when the optical signal (e.g., the first optical signal or the second optical signal) with a horizontal polarization state is received, the polarization beam splitter 160 may maintain a propagation direction of the optical signal. That is, the polarization beam splitter 160 may output the optical signal in the same direction as the propagation direction in which the optical signal is received. Thus, the optical signal with the horizontal polarization state may pass through the polarization beam splitter 160 while maintaining the propagation direction.

For example, when the optical signal with a vertical polarization state is received, the polarization beam splitter 160 may change a propagation direction of the optical signal by 90 degrees. That is, the polarization beam splitter 160 may output the optical signal by reflecting the optical signal in a direction that differs by 90 degrees from the propagation direction in which the optical signal is received. Thus, the optical signal with the vertical polarization state may pass through the polarization beam splitter 160 while changing the propagation direction.

The Faraday mirror 170 may reflect the optical signals (e.g., the first and second optical signals) output from the polarization beam splitter 160. That is, the optical signals reflected by the Faraday mirror 170 may return to the polarization beam splitter 160.

The Faraday mirror 170 may adjust polarization states of the optical signals. That is, when the optical signals are reflected, the Faraday mirror 170 may convert the polarization states of the optical signals. For example, when the optical signal (e.g., the first optical signal or the second optical signal) input to the Faraday mirror 170 has horizontal polarization, the optical signal reflected by the Faraday Mirror 170 may have vertical polarization. For example, when the optical signal input to the Faraday mirror 170 has vertical polarization, the optical signal reflected by the Faraday Mirror 170 may have horizon polarization.

In an embodiment, the Faraday mirror 170 may correct for polarization changes that may occur while reflecting the optical signals. Thus, the sensitivity due to the phase variation inside an interferometer is lowered, and the stability of the device 100 may be increased.

The optical detector 180 may convert the interference signal generated from the beam splitter 120 into an electrical signal and detect the electrical signal. The optical detector 180 may measure a half-wave voltage of the phase modulator 130 based on the detected interference signal. For example, the optical detector 180 may measure intensity of the detected interference signal. The intensity of the detected interference signal may be represented by a voltage (hereinafter referred to as a “detection voltage”). The optical detector 180 may measure the half-wave voltage of the phase modulator 130 by verifying the detection voltage at which a 180-degree phase shift occurs in the detected interference signal.

In an embodiment, the optical detector 180 may include an oscilloscope that converts the interference signal into an electrical signal and detects the electrical signal.

In an embodiment, each of the light source 110, the beam splitter 120, the phase modulator 130, the first polarization controller 140, the second polarization controller 150, the polarization beam splitter 160, the Faraday mirror 170, the optical detector 180, and the RF signal generator 190 may be connected via an optical fiber.

For example, the light source 110 and beam splitter 120, the beam splitter 120 and the optical detector 180, the beam splitter 120 and the first polarization controller 140, the beam splitter 120 and the phase regulator 130 may each be connected by the polarization-maintaining optical fiber for maintaining the polarization state of the optical signal. The phase regulator 130 and second polarization controller 150, the first polarization controller 140 and polarization beam splitter 160, the second polarization controller 150 and polarization beam splitter 160, polarization beam splitters 160 and Faraday mirrors 170 may each be connected by a single mode optical fiber.

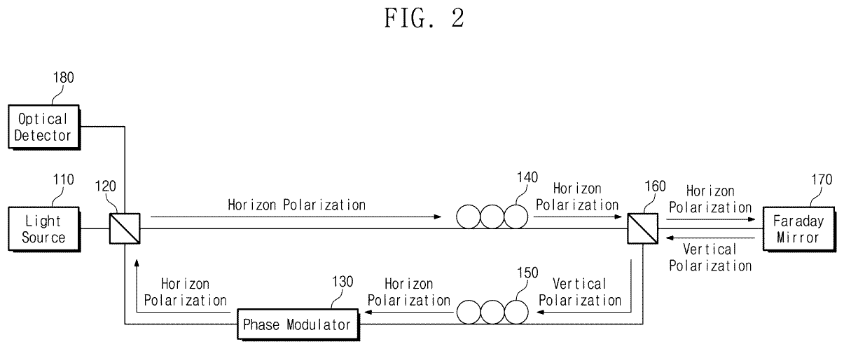

FIG. 2 illustrates an example of a propagation of the first optical signal in the device of FIG. 1. In FIG. 2, the crystal axis of a phase modulator 130 is assumed to be in a horizontal direction. In FIG. 2, the RF signal generator 190 of FIG. 1 is omitted for convenience of description.

Referring to FIGS. 1 and 2, a beam splitter 120 may separate an input optical signal into a first optical signal and a second optical signal having the same intensity. A polarization state of the separated first optical signal may be horizontal polarization. The separated first optical signal may be input to a polarization beam splitter 160 along a first path. A polarization state of the first optical signal input to the polarization beam splitter 160 may be horizontal polarization. The first optical signal input to the polarization beam splitter 160 may be output from the polarization beam splitter 160 while maintaining a propagation direction. The first optical signal output from the polarization beam splitter 160 may propagate along a second path to a Faraday mirror 170. The first optical signal propagating to the Faraday mirror 170 may be reflected from the Faraday Mirror 170 and returned to the polarization beam splitter 160 along the second path. In this case, a polarization state of the reflected first optical signal may be vertical polarization. Since the polarization state of the reflected first optical signal is vertical polarization, a propagation direction of the reflected first optical signal may be changed by 90 degrees by the polarization beam splitter 160. The first optical signal with the changed propagation direction may propagate through a third sub-path and then be input to a second polarization controller 150 through a second sub-path. A polarization state of the first optical signal input to the second polarization controller 150 may be converted into horizontal polarization. The first optical signal converted to horizontal polarization may be input to a phase modulator 130. A phase of the first optical signal input to the phase modulator 130 may not be adjusted. The first optical signal output from the phase modulator 130 may be input to the beam splitter 120 via a first sub-path. A polarization state of the first optical signal input to the beam splitter 120 may be horizontal polarization.

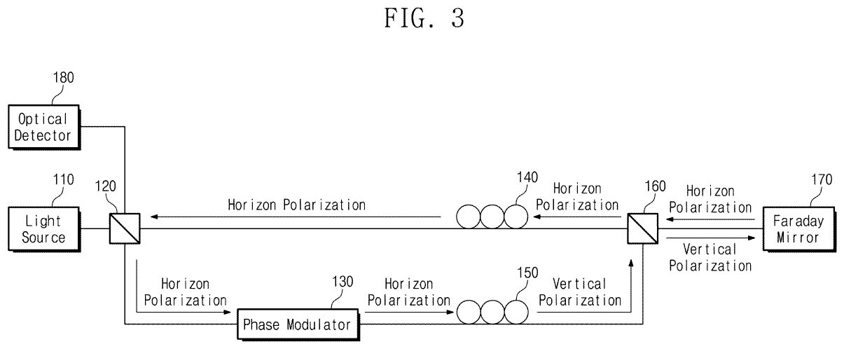

FIG. 3 illustrates an example of a propagation of the second optical signal in the device of FIG. 1. In FIG. 3, the crystal axis of a phase modulator 130 is assumed to be in a horizontal direction. In FIG. 3, the RF signal generator 190 of FIG. 1 is omitted for convenience of description.

Referring to FIGS. 1 and 3, a beam splitter 120 may separate an input optical signal into a first optical signal and a second optical signal having the same intensity. A polarization state of the separated second optical signal may be horizontal polarization. The separated second optical signal may propagate through a first sub-path and then be input to a phase modulator 130 through a second sub-path. A phase of the second optical signal input to the phase modulator 130 may be adjusted. A polarization state of the second optical signal output from the phase modulator 130 may be horizontal polarization. The second optical signal output from the phase modulator 130 may be input to a second polarization controller 150. A polarization state of the second optical signal input to the second polarization controller 150 may be converted to vertical polarization. The second optical signal converted to vertical polarization may be input to a polarization beam splitter 160 through a third sub-path. Since the polarization state of the second optical signal input to the polarization beam splitter 160 is vertical polarization, a propagation direction may be changed by 90 degrees by the polarization beam splitter 160. The second optical signal with a changed traveling direction may be output from the polarization beam splitter 160. The second optical signal output from the polarization beam splitter 160 may propagate along a second path to a Faraday mirror 170. The second optical signal propagating to the Faraday mirror 170 may be reflected from the Faraday Mirror 170 and returned to the polarization beam splitter 160 along the second path. In this case, a polarization state of the reflected second optical signal may be horizontal polarization. The reflected second optical signal may be output from the polarization beam splitter 160 while maintaining a propagation direction and input to the beam splitter 120 along a first path. A polarization state of the second optical signal input to the beam splitter 120 may be horizontal polarization.

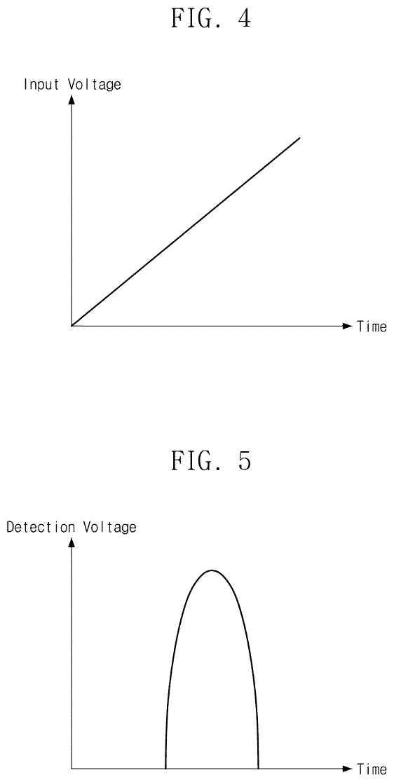

FIG. 4 illustrates an example of an input voltage applied to the device of FIG. 1. In FIG. 4, the horizontal axis represents time and the vertical axis represents an input voltage to be applied.

Referring to FIGS. 1 and 4, a RF signal generator 190 may apply an input voltage that increases linearly (or gradually) to a phase modulator 130. In an embodiment, the input voltage may increase from 0 V to 10 V.

The phase modulator 130 may adjust a phase of a second optical signal propagating along a third path based on the applied input voltage.

FIG. 5 illustrates an example of an interference signal detected in the device of FIG. 1. In FIG. 5, the horizontal axis represents time, and the vertical axis represents a detection voltage of a detected interference signal.

Referring to FIGS. 1 and 5, an optical detector 180 may detect an interference signal in the form of a sign. The optical detector 180 may measure a half-wave voltage of a phase modulator 130 by verifying a detection voltage at which 180-degree phase shift occurs in the detected interference signal.

The half-wave voltage of the phase modulator 130 may be related to the detection voltage and a phase variation of the detected interference signal. Specifically, the half-wave voltage of the phase modulator 130 may be measured based on Equations 1 and 2 below.

$$V = R * {I}_{0} * ( 1 + cos ∅ ) \qquad [ Equation 1 ]$$

$$∅ = π * \frac{V}{{V}_{π}} \qquad [ Equation 2 ]$$

In Equations 1 and 2, V may represent the detection voltage, R may represent a sensitivity, which is the rate at which the optical detector 180 converts the interference signal into a voltage, I₀ may represent intensity of an input optical signal, Ø may represent a phase variation of the interference signal, and V_{π} may represent the half-wave voltage of the phase modulator 130. In other words, the optical detector 180 may measure the half-wave voltage of the phase modulator 130 by analyzing the detection voltage when the phase variation of the interference signal reaches 180 degrees.

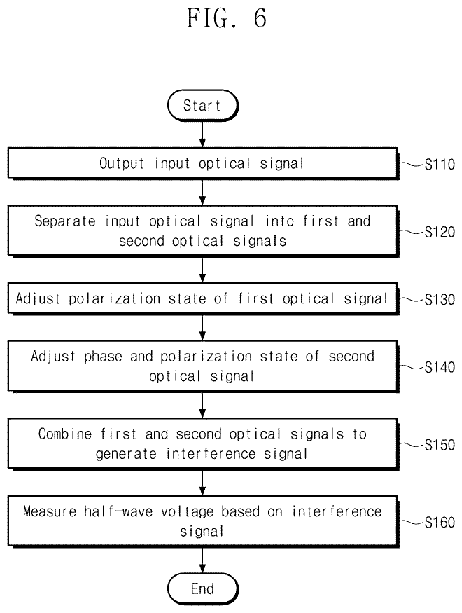

FIG. 6 illustrates an example of operation of a device for measuring a half-wave voltage of a phase modulator, according to an embodiment of the present disclosure.

Referring to FIGS. 1 and 6, a device 100 may perform steps S110 to S160. In step S110, the device 100 may output an input optical signal. For example, a light source 110 may output the input optical signal.

In step S120, the device 100 may separate the input optical signal into a first optical signal and a second optical signal. For example, a beam splitter 120 may separate the input optical signal into the first optical signal and the second optical signal. The first optical signal may propagate along an optical path including a first path, a second path, and a third path in a first order, and the second optical signal may propagate the optical path in a second order. The first order may refer to the sequence of the first path, the second path, and the third path, and the second order may refer to the sequence of the third path, the second route, and the first path.

In step S130, the device 100 may adjust a polarization state of the first optical signal. For example, a first polarization controller 140, a second polarization controller 150, and a Faraday mirror 170 may adjust the polarization state of the first optical signal.

In step S140, the device 100 may adjust a phase and a polarization state of the second optical signal. For example, a phase modulator 130 may adjust the phase of the second optical signal, and the second polarization controller 150 and the Faraday mirror 170 may adjust the polarization state of the second optical signal. In an embodiment, the first polarization controller 140 may correct a polarization error of the second optical signal.

In an embodiment, the device 100 may adjust the phase of the second optical signal based on an input voltage applied to the phase modulator 130. For example, a RF signal generator 190 may linearly increase the input voltage applied to the phase modulator 130. The phase modulator 130 may adjust the phase of the second optical signal based on the increased input voltage.

In step S150, the device 100 may combine the adjusted first optical signal and the adjusted second optical signal to generate an interference signal. For example, the beam splitter 120 may generate the interference signal by combining the first optical signal whose polarization state is adjusted and the second optical signal whose phase and polarization state are adjusted.

In step S160, the device 100 may measure a half-wave voltage of the phase modulator 130 based on the interference signal. For example, the optical detector 180 may detect the interference signal generated from the beam splitter 120. The optical detector 180 may measure the half-wave voltage of the phase modulator 130 based on a detection voltage and a phase variation of the detected interference signal.

In the above embodiments, components according to the present disclosure are described by using the terms “first”, “second”, “third”, and the like. However, the terms “first”, “second”, “third”, and the like may be used to distinguish components from each other and do not limit the present disclosure. For example, the terms “first”, “second”, “third”, and the like do not involve an order or a numerical meaning of any form.

The above descriptions are detail embodiments for carrying out the present disclosure. Embodiments in which a design is changed simply or which are easily changed may be included in the present disclosure as well as an embodiment described above. In addition, technologies that are easily changed and implemented by using the above embodiments may be included in the present disclosure.

A device for measuring a half-wave voltage of a phase modulator according to the present disclosure may accurately measure the half-wave voltage of the phase modulator in the high-speed operating environment of optical communication systems. Since the device for measuring the half-wave voltage is designed considering the characteristics of pulsed optical signals, it can overcome the limitations of conventional CW optical signal-based technologies.

According to the present disclosure, a device for measuring a half-wave voltage of a phase modulator may perform measurements considering pulse repetition frequency and signal-to-noise ratio (SNR), thereby providing high reliability even in high-speed optical communication and laser-based systems.

Furthermore, by utilizing the Faraday-Michelson interferometer structure, two optical signals propagate along optical paths of the same length. As a result, high interference quality can be maintained without the need for a phase stabilization device. Additionally, by removing the phase stabilization device, both simplification of the device configuration and improvement of operational efficiency can be achieved.

What is claimed is:

1. A device for measuring half-wave voltage, comprising:
a light source configured to output an input optical signal;
a beam splitter configured to separate the input optical signal into a first optical signal and a second optical signal, and generate an interference signal based on the first optical signal and the second optical signal;
a plurality of polarization controllers each configured to adjust polarization states of the optical signals;
a phase modulator configured to adjust a phase of the second optical signal based on an input voltage;
a polarization beam splitter configured to determine propagation directions of the first optical signal and the second optical signal;
a Faraday mirror configured to reflect by converting polarization states of the optical signals output from the polarization beam splitter; and
an optical detector configured to detect the interference signal, and measure the half-wave voltage of the phase modulator based on the detected interference signal;
wherein the first optical signal and the second optical signal propagate along the same optical path in opposite directions.

2. The device of claim 1, wherein the input optical signal is a continuous-wave optical signal or a pulsed optical signal.

3. The device of claim 2, wherein the plurality of polarization controllers include:
a first polarization controller configured to correct the polarization states of the optical signals; and
a second polarization controller configured to convert the polarization states of the optical signals by 90 degrees.

4. The device of claim 3, wherein the optical path includes:
a first path including the first polarization controller;
a second path between the polarization beam splitter and the Faraday mirror; and
a third path including the phase modulator and the second polarization controller.

5. The device of claim 4, wherein the first optical signal propagates sequentially through the first path, the second path, and the third path, and
wherein the second optical signal propagates sequentially through the third path, the second path, and the first path.

6. The device of claim 5, wherein the beam splitter combines the first optical signal propagated through the third path and the second optical signal propagated through the first path to generate the interference signal.

7. The device of claim 6, wherein the separated first optical signal has a first polarization state,
wherein the Faraday mirror converts the separated first optical signal to have a second polarization state,
wherein the second polarization controller converts the converted first optical signal to have the first polarization state, and
wherein the first polarization state and the second polarization state are orthogonal.

8. The device of claim 7, wherein the separated second optical signal has the first polarization state,
wherein the second polarization controller converts the separated second optical signal to have the second polarization state,
wherein the Faraday mirror converts the converted second optical signal to have the first polarization state.

9. The device of claim 8, wherein the first polarization state is a polarization state in a direction aligned with a crystal axis of the phase modulator.

10. The device of claim 8, wherein the separated first optical signal and the separated second optical signal have the same intensity.

11. The device of claim 8, wherein the device is based on a Faraday-Michelson interferometer.

12. The device of claim 8, wherein the beam splitter includes a polarization-maintaining optical fiber to maintain the polarization states of the optical signals.

13. The device of claim 8, wherein the first path includes a delay-matching optical fiber to match the length with the second path.

14. The device of claim 8, wherein the optical detector is an oscilloscope configured to convert the interference signal into an electrical signal, and detect the electrical signal.

15. The device of claim 8, further comprising an RF signal generator configured to apply the input voltage to the phase modulator.

16. A method of operating a device for measuring half-wave voltage, the method comprising:
outputting an input optical signal;
separating the input optical signal into a first optical signal and a second optical signal, wherein the first optical signal propagates in a first direction, and the second optical signal propagates in a second direction;
adjusting a polarization state of the first optical signal;
adjusting a phase and a polarization state of the second optical signal;
combining the adjusted first optical signal and the adjusted second optical signal to generate an interference signal; and
measuring the half-wave voltage based on the interference signal.

17. The method of claim 16, wherein the input optical signal is a continuous-wave optical signal or a pulsed optical signal.

18. The method of claim 17, wherein the optical path includes a first path, a second path, and a third path,
wherein the first direction is in the order of the first path, the second path, and the third path, and
wherein the second direction is in the order of the third path, the second path, and the first path.

19. The method of claim 18, wherein the adjusting of the phase and the polarization state of the second optical signal includes adjusting the phase of the second optical signal based on the input voltage.

20. The method of claim 19, wherein measuring of the half-wave voltage based on the interference signal includes:
detecting the interference signal; and
measuring the half-wave voltage based on detection voltage and phase variation of the detected interference signal.
